(19) United States
(12) Patent Application Publication
(10) Pub. No.: US 2012/0135679 A1
(43) Pub. Date: May 31, 2012

(54) Electronic Equipment System, Electronic Equipment and Connecting Device

(75) Inventors: Tomohiro Yoshimura, Osaka (JP); Tomoki Nakajima, Osaka (JP)

(73) Assignee: Sharp Kabushiki Kaisha, Osaka (JP)

(21) Appl. No.: 13/306,691

(22) Filed: Nov. 29, 2011

(30) Foreign Application Priority Data
Nov. 29, 2010 (JP) JP2010-265553

(51) Int. Cl. H04W 4/00

(52) U.S. Cl. 455/39

(57) ABSTRACT

An electronic equipment system is constructed by connecting a USB 3.0 socket 13 of electronic equipment 1 to a USB 3.0 plug 23 of a connecting device 2. The connecting device 2 includes no antenna and the electronic equipment 1 includes an antenna 12. The electronic equipment 1 and the connecting device 2 perform data input/output in accordance with the USB 2.0 communication protocol, and data is sent/received by the antenna 12 through second signal lines 15 and fourth signal lines 25 not used for the USB 2.0. Since there is no need to provide an antenna in the connecting device 2, the connecting device 2 may be further downsized.

### CROSS-REFERENCE TO RELATED APPLICATIONS

This Nonprovisional application claims priority under 35 U.S.C.§119(a) on Patent Application No. 2010-265553 filed in Japan on Nov. 29, 2010, the entire contents of which are hereby incorporated by reference.

### BACKGROUND

1. Technical Field

The present invention relates to electronic equipment and a connecting device for providing a specific function to the electronic equipment, and more particularly, it relates to an electronic equipment system, electronic equipment and a connecting device for making wireless communications executable by connecting the connecting device to the electronic equipment.

2. Description of Related Art

In some electronic equipment such as a notebook PC (personal computer), a connecting device having a function not possessed by the electronic equipment may be connected thereto so as to use the function. For example, even electronic equipment not having a wireless communication function may execute communications by using a wireless LAN (local area network) when a wireless LAN adapter is connected thereto as a connecting device. As a connection interface used for connecting such a connecting device to electronic equipment, for example, a USB (universal serial bus) is used. Japanese Utility Model Registration No. 3151486 discloses USB 3.0 as an example of the connection interface.

### SUMMARY OF THE INVENTION

As a connecting device has a smaller size, it is more easily attached/removed to/from electronic equipment and change in size of the electronic equipment caused when connected is smaller, and hence, it is handier. Therefore, a connecting device is required to be as small as possible. A connecting device for providing a wireless communication function to electronic equipment such as a wireless LAN adapter, however, should be equipped with an antenna, and an antenna needs to have a given size, which leads to a problem of a limit in downsizing.

The present invention was devised in consideration of these circumstances, and an object of the invention is providing an electronic equipment system, electronic equipment and a connecting device for realizing further downsizing of a connecting device used for performing wireless communications.

The electronic equipment system of the invention includes electronic equipment; and a connecting device to be connected to the electronic equipment, and the electronic equipment includes an antenna; and a transmission data output unit for outputting, to the connecting device, transmission data to be transmitted to outside, and the connecting device includes a modulation unit for modulating the transmission data having been input from the electronic equipment; and a first output unit for outputting the modulated transmission data to the electronic equipment, and the electronic equipment sends the modulated transmission data having been input from the connecting device to the outside by using the antenna.

In the electronic equipment system of the invention, the electronic equipment receives data by using the antenna and outputs the reception data to the connecting device, and the connecting device further includes a demodulation unit for demodulating the reception data having been input from the electronic equipment; and a second output unit for outputting the demodulated reception data to the electronic equipment.

In the electronic equipment system of the invention, the electronic equipment further includes a first connector complying with a second interface that has compatibility with a first interface for performing data input/output through one or a plurality of signal lines and performs data input/output through signal lines larger in number than the first interface; and a plurality of signal lines connected to the first connector, the connecting device further includes a second connector to be connected to the first connector;

and a plurality of signal lines connected to the second connector, the transmission data output unit outputs the transmission data to the connecting device through some signal lines of the plurality of signal lines connected to the first connector in accordance with a communication protocol for the first interface, the electronic equipment outputs the reception data to the connecting device through other signal lines of the plurality of signal lines, the second output unit outputs the demodulated reception data to the electronic equipment through some signal lines of the plurality of signal lines connected to the second connector in accordance with the communication protocol for the first interface, and the first output unit outputs the modulated transmission data to the electronic equipment through other signal lines of the plurality of signal lines.

In the electronic equipment system of the invention, the electronic equipment receives, as an input, the demodulated reception data from the connecting device through some signal lines of the plurality of the signal lines connected to the first connector in accordance with the communication protocol for the first interface, and receives, as an input, the modulated transmission data from the connecting device through other signal lines of the plurality of signal lines, and the connecting device receives, as an input, the transmission data from the electronic equipment through some signal lines of the plurality of signal lines connected to the second connector in accordance with the communication protocol for the first interface, and receives, as an input, the reception data from the electronic equipment through other signal lines of the plurality of signal lines.

In the electronic equipment system of the invention, the first interface is USB 2.0, and the second interface is USB 3.0.

The electronic equipment of the invention includes a connector to be connected to an external connecting device; an antenna; and a transmission data output unit for outputting, to the external connecting device connected to the connector, transmission data to be sent to outside by using the antenna, and modulated transmission data is input from the external connecting device and the modulated transmission data being is to the outside through the antenna, data is received by the antenna and the reception data is output to the external connecting device, and demodulated reception data is input from the external connecting device.

The connecting device to be connected to external electronic equipment of the invention includes a modulation unit for modulating data input from the connected external electronic equipment so as to be sent through wireless communications; a first output unit for outputting the modulated data to the electronic equipment; a demodulation unit for demodulating data input from the electronic equipment; and a second output unit for outputting the demodulated data to the electronic equipment.

According to the invention, the connecting device to be connected to the electronic equipment does not include an antenna but the electronic equipment includes the antenna. The connecting device modulates data to be sent to the outside, makes it sent from the antenna of the electronic equipment and demodulates data received by the antenna of the electronic equipment, and thus, it executes wireless communications by utilizing the antenna of the electronic equipment.

In one aspect of the present invention, the electronic equipment and the connecting device are connected to each other through the connector complying with the second interface compatible with the first interface. The electronic equipment and the connecting device perform data input/output by using the first interface and performs data input/output for making the antenna send/receive data by utilizing signal lines not used by the first interface.

In another aspect of the invention, the electronic equipment and the connecting device are connected to each other through the connector complying with the USB 3.0 and perform the data input/output in accordance with the USB 2.0 communication protocol.

Since there is no need to provide an antenna in the connecting device in this invention, the connecting device may be further downsized. Furthermore, the entire size of the electronic equipment system including the electronic equipment and the connecting device may be further reduced as compared with a conventional one, and hence, the portability and the convenience of the electronic equipment system may be improved. Thus, the present invention exhibits excellent effects.

The above and further objects and features of the invention will more fully be apparent from the following detailed description with accompanying drawings.

### BRIEF DESCRIPTION OF THE SEVERAL VIEWS OF THE DRAWINGS

FIG. 1 is a conceptual diagram illustrating the appearance of an electronic equipment system according to the invention;

FIG. 2 is a block diagram illustrating the internal configuration of electronic equipment according to the invention;

FIG. 3 is a block diagram illustrating the internal configuration of a connecting device according to the invention;

FIG. 4 is a block diagram illustrating a state where the connecting device is connected to the electronic equipment;

FIG. 5 is a flowchart illustrating procedures for sending data to the outside by the electronic equipment system of the invention; and

FIG. 6 is a flowchart illustrating procedures for receiving data from the outside by the electronic equipment system of the invention.

### DETAILED DESCRIPTION

The present invention will now be specifically described on the basis of accompanying drawings illustrating an embodiment thereof.

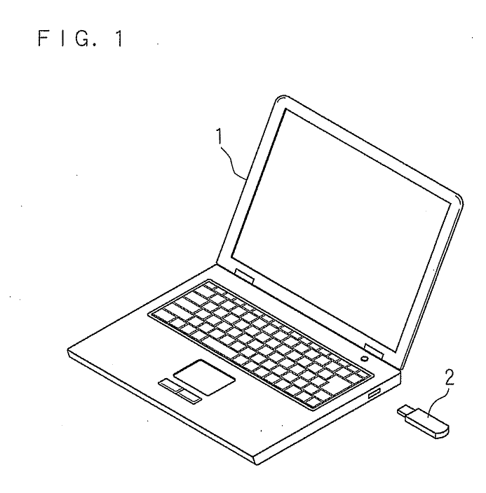

FIG. 1 is a conceptual diagram illustrating the appearance of an electronic equipment system of the invention. The electronic equipment system of this invention includes electronic equipment 1 such as a notebook PC or a game machine and a connecting device 2 to be connected to the electronic equipment 1. The connecting device 2 is a device for providing a wireless communication function to the connected electronic equipment 1, such as a wireless LAN adapter or a wireless mouse receiver.

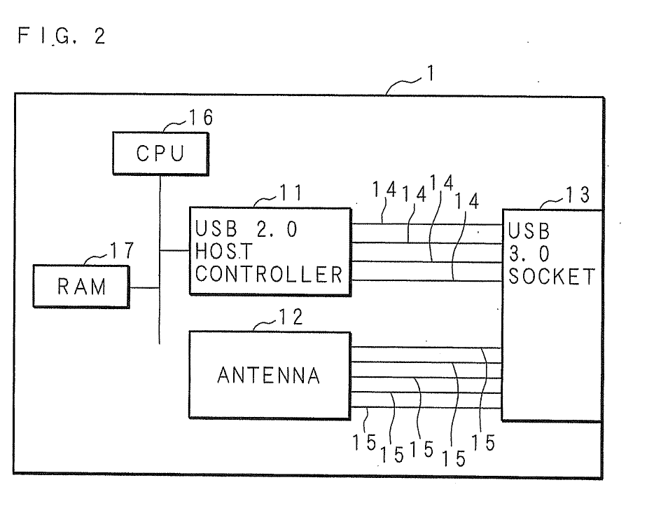

FIG. 2 is a block diagram illustrating the internal configuration of the electronic equipment 1 of the invention. The electronic equipment 1 includes a USB 3.0 socket 13, that is, a first connector to be connected to the connecting device 2. The USB 3.0 socket 13 is a connector complying with USB 3.0 (a second interface) used for performing data input/output. The USB 3.0 is an interface for inputting/outputting data by using 9 signal lines, and hence, 9 signal lines are connected to the USB 3.0 socket 13. Furthermore, the USB 3.0 has backward compatibility with USB 2.0 (a first interface), that is, an alternate interface. The USB 2.0 is an interface for inputting/outputting data by using 4 signal lines. Among the 9 signal lines connected to the USB 3.0 socket 13, 4 signal lines to be used by the USB 2.0 are herein designated as first signal lines 14 and the other 5 signal lines not used by the USB 2.0 are herein designated as second signal lines 15.

The first signal lines 14 are connected to a USB 2.0 host controller 11. The USB 2.0 host controller 11 executes data input/output processing on a host side in accordance with USB 2.0 communication protocol. The USB 2.0 host controller 11 is connected to a CPU (central processing unit) 16 executing information processing necessary for the electronic equipment 1. The CPU 16 is connected to a RAM (random access memory) for storing data created in accordance with the information processing. The CPU 16 is further connected to various devices not shown, such as a display, for executing various processing necessary for the electronic equipment 1.

The electronic equipment 1 further includes an antenna 12. The antenna 12 is connected to the second signal lines 15. The antenna 12 is used for sending/receiving data through wireless communications to/from external communication equipment not shown such as a wireless LAN access point or a wireless mouse.

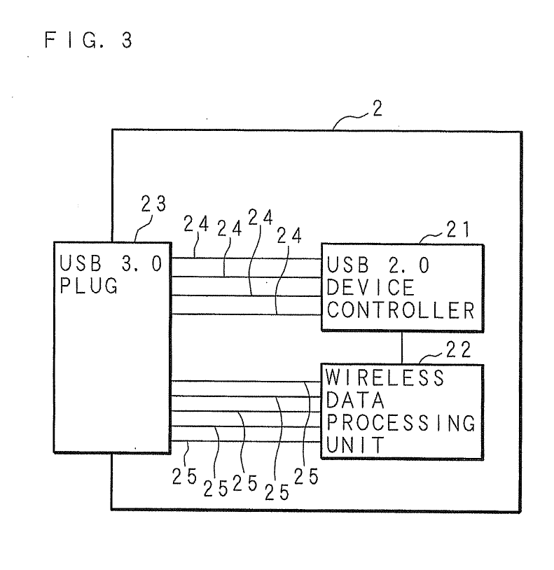

FIG. 3 is a block diagram illustrating the internal configuration of the connecting device 2 of the invention. The connecting device 2 includes a USB 3.0 plug 23, that is, a second connector to be connected to the USB 3.0 socket 13. The USB 3.0 plug 23 is a connector complying with the USB 3.0 and is connected to 9 signal lines. Among the 9 signal lines, 4 signal lines used by the USB 2.0 are herein designated as third signal lines 24 and the other 5 signal lines not used by the USB 2.0 are herein designated as fourth signal lines 25. The third signal lines 24 are connected to a USB 2.0 device controller 21. The USB 2.0 device controller 21 executes data input/output processing on a device side in accordance with the USB 2.0 communication protocol.

Furthermore, the USB 2.0 device controller 21 is connected to a wireless data processing unit 22. The wireless data processing unit 22 executes processing necessary for sending/receiving data to/from the outside through the wireless communications, such as demodulation of data received through the wireless communications and modulation of data to be sent through the wireless communications. The wireless data processing unit 22 is connected to the fourth signal lines 25.

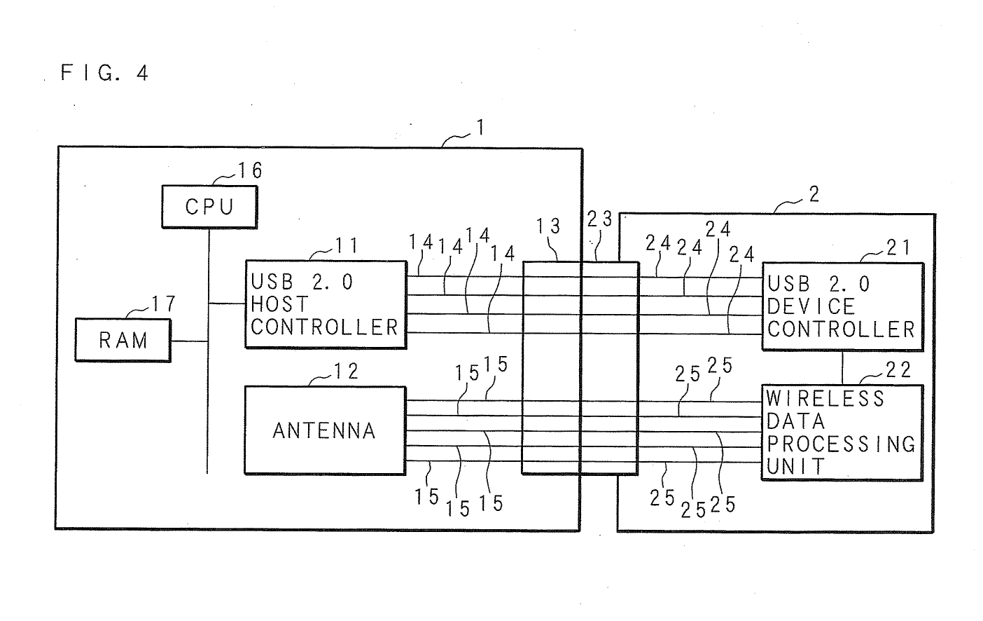

FIG. 4 is a block diagram illustrating a state where the connecting device 2 is connected to the electronic equipment 1. The connecting device 2 is connected to the electronic equipment 1 by connecting the USB 3.0 plug 23 to the USB 3.0 socket 13. Connection pins provided inside the USB 3.0 socket 13 and the USB 3.0 plug 23 are disposed so that the third signal lines 24 may be connected to the first signal lines 14 and the fourth signal lines 25 may be connected to the second signal lines 15 when the USB 3.0 plug 23 is connected to the USB 3.0 socket 13. Specifically, when the connecting device 2 is connected to the electronic equipment 1, the USB 2.0 host controller 11 and the USB 2.0 device controller 21 are physically connected to each other through the first signal lines 14 and the third signal lines 24. Also, the antenna 12 and the wireless data processing unit 22 are physically connected to each other through the second signal lines 15 and the fourth signal lines 25.

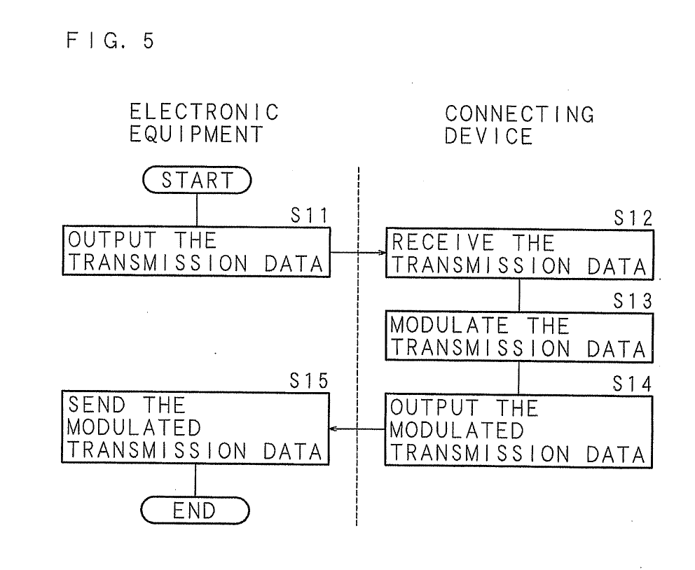

FIG. 5 is a flowchart illustrating procedures for sending data to the outside by the electronic equipment system of the invention. The USB 2.0 host controller 11 receives, as an input from the CPU 16, transmission data to be sent to the outside and outputs the transmission data through the first signal lines 14 to the connecting device 2 in accordance with the USB 2.0 communication protocol (S11). The USB 2.0 device controller 21 receives, as an input, the transmission data through the third signal lines 24 connected to the first signal lines 14 in accordance with the USB 2.0 communication protocol (S12). The USB 2.0 device controller 21 outputs the input transmission data to the wireless data processing unit 22. The wireless data processing unit 22 modulates the transmission data so as that it may be sent by the antenna 12 (S13), and outputs the modulated transmission data to the electronic equipment 1 through the fourth signal lines 25 (S14). The antenna 12 receives, as an input, the modulated transmission data through the second signal lines 15 connected to the fourth signal lines 25, and sends the input modulated transmission data to external communication equipment not shown (S15). Thus, the electronic equipment system terminates the transmission processing.

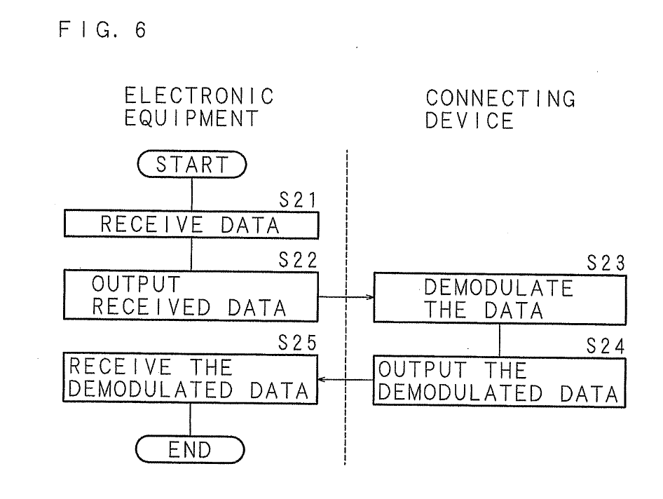

FIG. 6 is a flowchart illustrating procedures for receiving data from the outside by the electronic equipment system of this invention. When the antenna 12 receives data sent from external communication equipment not shown (S21), it outputs the thus received reception data to the connecting device 2 through the second signal lines 15 (S22). The wireless data processing unit 22 receives, as an input, the reception data through the fourth signal lines 25 connected to the second signal lines 15 and demodulates the input reception data so that it may be dealt with by the USB 2.0 device controller 21 (S23). The wireless data processing unit 22 inputs the demodulated reception data to the USB 2.0 device controller 21. The USB 2.0 device controller 21 outputs the demodulated reception data to the electronic equipment 1 through the third signal lines 24 in accordance with the USB 2.0 communication protocol (S24). The USB 2.0 host controller 11 receives, as an input, the demodulated reception data through the first signal lines 14 connected to the third signal lines 24 in accordance with the USB 2.0 communication protocol (S25). Thus, the electronic equipment system terminates the receive processing. After terminating the receive processing, the USB 2.0 host controller 11 outputs the reception data to the CPU 16, and the

CPU 16 executes information processing using the reception data for, for example, displaying an image corresponding to the reception data on a display.

As described above, according to the present invention, the connecting device 2 does not include an antenna but the electronic equipment 1 includes the antenna 12, and the connecting device 2 performs wireless communications for sending/receiving data to/from the outside by utilizing the antenna 12 provided in the electronic equipment 1. Since there is no need to provide an antenna in the connecting device 2, the connecting device 2 may be further downsized. Furthermore, the electronic equipment 1 naturally has a larger size than the connecting device 2 in general, and hence, it is easy to suppress the size increase even when it is provided with the antenna 12. Therefore, according to the present invention, the entire size of the electronic equipment system including the electronic equipment 1 and the connecting device 2 may be further downsized as compared with a conventional one, and the portability and the convenience of the electronic equipment system may be improved.

Incidentally, although the numbers of the second signal lines 15 and the fourth signal lines 25 are both 5 in this embodiment, the numbers of these signal lines are not limited to 5 but the invention may be embodied with the numbers of the second signal lines 15 and the fourth signal lines 25 respectively set to 1 to 4. For example, the electronic equipment 1 may use, as the second signal lines 15, merely 1 to 4 signal lines out of the 5 signal lines apart from the first signal lines 14. Furthermore, the connecting device 2 may use, as the fourth signal lines 25, merely 1 to 4 signal lines out of the 5 signal lines apart from the third signal lines 24. Alternatively, in the connecting device 2, the third signal lines 24 and 1 to 4 fourth signal lines 25 alone may be connected to the USB 3.0 plug 23 with no other signal lines connected thereto.

Moreover, although the electronic equipment 1 performs the data input/output by utilizing the USB 2.0 in this embodiment, the electronic equipment 1 of this invention may perform the data input/output by utilizing the USB 3.0 in addition to the USB 2.0. For example, the electronic equipment 1 may include a USB 3.0 host controller connected to the first signal lines 14 and the second signal lines 15 instead of the USB 2.0 host controller 11 with the second signal lines 15 connected to the antenna 12 in parallel. In this case, the electronic equipment 1 corresponds to a part of the electronic equipment system of this invention when the connecting device 2 is connected thereto, and it performs the data input/output by utilizing the USB 3.0 when another connecting device employing the USB 3.0 is connected thereto.

Furthermore, the first interface of the invention is the USB 2.0 and the second interface is the USB 3.0 in this embodiment, which does not limit the invention. The present invention may be practiced by using any interface other than the USB 2.0 and the USB 3.0.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. An electronic equipment system, comprising:
an electronic equipment; and
a connecting device to be connected to the electronic equipment,
wherein the electronic equipment includes:
an antenna; and
a transmission data output unit for outputting, to the connecting device, transmission data to be transmitted to outside,
the connecting device includes:
a modulation unit for modulating the transmission data having been input from the electronic equipment; and
a first output unit for outputting the modulated transmission data to the electronic equipment, and
the electronic equipment sends the modulated transmission data having been input from the connecting device to the outside by using the antenna.

2. The electronic equipment system according to claim 1,
wherein the electronic equipment receives data by using the antenna and outputs the reception data to the connecting device, and
the connecting device further includes:
a demodulation unit for demodulating the reception data having been input from the electronic equipment; and
a second output unit for outputting the demodulated reception data to the electronic equipment.

3. The electronic equipment system according to claim 2,
wherein, the electronic equipment further includes:
a first connector complying with a second interface that has compatibility with a first interface for performing data input/output through one or a plurality of signal lines and performs data input/output through signal lines larger in number than the first interface; and
a plurality of signal lines connected to the first connector,
the connecting device further includes:
a second connector to be connected to the first connector; and
a plurality of signal lines connected to the second connector,
the transmission data output unit outputs the transmission data to the connecting device through some signal lines of the plurality of signal lines connected to the first connector in accordance with a communication protocol for the first interface,
the electronic equipment outputs the reception data to the connecting device through other signal lines of the plurality of signal lines,
the second output unit outputs the demodulated reception data to the electronic equipment through some signal lines of the plurality of signal lines connected to the second connector in accordance with the communication protocol for the first interface, and
the first output unit outputs the modulated transmission data to the electronic equipment through other signal lines of the plurality of signal lines.

4. The electronic equipment system according to claim 3,
wherein the electronic equipment receives, as an input, the demodulated reception data from the connecting device through some signal lines of the plurality of the signal lines connected to the first connector in accordance with the communication protocol for the first interface, and receives, as an input, the modulated transmission data from the connecting device through other signal lines of the plurality of signal lines, and
the connecting device receives, as an input, the transmission data from the electronic equipment through some signal lines of the plurality of signal lines connected to the second connector in accordance with the communication protocol for the first interface, and receives, as an input, the reception data from the electronic equipment through other signal lines of the plurality of signal lines.

5. The electronic equipment system according to claim 3,
wherein the first interface is USB 2.0, and
the second interface is USB 3.0.

6. The electronic equipment system according to claim 4,
wherein the first interface is USB 2.0, and
the second interface is USB 3.0.

7. An electronic equipment, comprising:
a connector to be connected to an external connecting device;
a data output unit for outputting, to the external connecting device connected to the connector, transmission data to be sent to outside;
an antenna for sending, to the outside, modulated transmission data having been input from the external connecting device, and for receiving data to be sent to the external connecting device; and
a data input unit for being input demodulated reception data from the external connecting device.

8. A connecting device to be connected to external electronic equipment, comprising:
a modulation unit for modulating data input from the connected external electronic equipment so as to be sent through wireless communications;
a first output unit for outputting the modulated data to the electronic equipment;
a demodulation unit for demodulating data input from the electronic equipment; and
a second output unit for outputting the demodulated data to the electronic equipment.
